(19) United States
(12) Patent Application Publication
(10) Pub. No.: US 2013/0045358 A1
(43) Pub. Date: Feb. 21, 2013

(54) PROTECTIVE COATING COMPOSITION

(71) Applicants: Darren James Swindells, Broadmeadows (AU); John Scheirs, Moorabbin (AU); Robin William Cranston, Ivanhoe (AU); Francis Gregory Dean, Belmont (AU); Damian Fullston, Highett (AU); Martin Willem Prins, Barwon Heads (AU)

(72) Inventors: Darren James Swindells, Broadmeadows (AU); John Scheirs, Moorabbin (AU); Robin William Cranston, Ivanhoe (AU); Francis Gregory Dean, Belmont (AU); Damian Fullston, Highett (AU); Martin Willem Prins, Barwon Heads (AU)

(73) Assignee: CTE PTY LTD, Broadmeadows, Victoria (AU)

(21) Appl. No.: 13/395,397

(22) PCT Filed: Sep. 10, 2010
(86) PCT No.: PCT/AU2010/001177

§ 371 Date: Sep. 19, 2012

(30) Foreign Application Priority Data
Sep. 11, 2009 (AU) 2009904452

(51) Int. Cl. C09D 183/04; B32B 3/00; B32B 5/02; B32B 27/02; C08K 3/36; C08K 3/34

(52) U.S. Cl. 428/141; 524/588; 524/447; 524/443; 442/59; 442/169

(57) ABSTRACT

A coating composition resistant to heat, flame and molten metal when applied as coating to a substrate. The composition includes an elastomeric binder and a particulate filler dispersed in the binder. The filler comprises particles of high aspect ratio in two dimensions relative to a third that co-operate when in a coating to provide a barrier within the binder. Also disclosed are an assembly comprising a substrate with a coating thereon, a fabric assembly resistant to spills and splashes of molten metal and a flame resistant building product.

### FIELD OF THE INVENTION

This invention relates generally to protective coating compositions, and in certain aspects to coating compositions resistant to heat, flame and/or molten metal.

In one application, the coating compositions are useful as a fabric coating for protecting industrial workers from spills and splashes of molten metal. In other applications, the coating compositions may be provided on substrates such as building panels, awnings, canvas, fibreglass sheeting, etc. to enhance the resistance of the panels to heat and/or flame.

### BACKGROUND OF THE INVENTION

There are many occupations, from firefighters to foundry hands, in which protective clothing must be worn to prevent exposure to radiant heat, or contact with flame or with spills or splashes of molten metal. Contact with molten metal is particularly problematic as the requisite garments have a relatively short life because they are quite quickly damaged by contact with molten metal. For example, in some industrial settings, outer protective garments may have to be discarded and interchanged every few weeks.

U.S. Pat. No. 4,540,617 discloses fabric articles composed of a flame-resistant, heat-resistant fabric of carbon fibers and heat-resistant synthetic fibres, with a flame resistant coating of a silicone or melamine resin. The preferred coatings are silicone resins with 20-50 wt % inorganic fillers such as silica, mica, alumina, titanium dioxide and the like. Silicone based flame-resistant textile coatings (optimally having metal hydrate additives and calcium carbonate as a filler) are also described in US patent application 2007/0190872. In US patent application 2008/0242176, there is disclosed a fabric especially for gloves that comprises aramid fibres impregnated with a silicone rubber, i.e. polysiloxane, which may include a filler of silica fume or carbon black.

US patent application 2008/0282455 describes printing onto a fabric a layer of spaced guard plates of resin material that expands on heating to provide a flame retardant layer. The plates may be a thermosetting silicone and are preferably intumescent.

There have also been disclosures directed to the specific object of providing protection from molten metal. For example international patent publication WO 2007/107572 discloses a ceramic-additive composition for rendering a fabric resistant to molten metal. The composition includes a cross-linkable polymer such as polyurethane, a filler of ceramic particles such as silicon carbide, and a flame retardant. The publication reports that a fabric coated with the composition performed well in a recognised standard test in which 200 g of molten iron at about 1400° C. was poured onto the face of the fabric at a specified angle from a specified height. US patent application 2008/0038972 discloses a fabric protective against molten metal comprising a base fabric of non-melt fibres treated on one or both sides with a cross-linkable polymer that forms a matrix with the fibres of the base fabric. Ceramic particles are suspended in the matrix which also incorporates a flame retardant. The fabric was tested by the same standard test as mentioned above, first with molten iron at 1400° C. and then with molten aluminium at 780° C., and was found to perform better than the untreated base fabric.

It is recognised that the danger of damage from molten metal splashes arises not just from the temperature of the melt, but also from the degree to which the particular molten metal tends to stick or adhere to the surface it contacts. Thus, although molten aluminium and zinc are at substantially lower temperatures than molten iron or molten steel, they have a greater tendency to stick at least momentarily to the surface and this adhesion greatly increases the transfer of damaging heat. It is thus desirable for a protective fabric adaptable to this role both to withstand the absolute temperature of the molten metal and to efficiently deflect it away.

A molten metal widely used in industrial foundries and like premises is stainless steel, which has a melt temperature typically around 1640° C.

The above discussion focuses on the protection of personnel in high temperature environments, but objects too can require protection from radiant heat and flame.

Construction components such as building panels, especially composite or reconstituted wood panels, are good examples.

It is an object of the invention to provide a coating composition that, when applied to a substrate, is resistant to heat, flame and/or molten metal.

It is an object of the invention, at least in one or more aspects, to provide a protective system that is effective against splashes and spills of both lower temperature stickier molten metals such as aluminium and zinc and higher temperature molten metals such as iron and steel. It is also preferred that such a protective system is able to remain functional for longer than current protective systems in an environment of molten metal splashes and spills, and that the protective system should be economically attractive in terms of its base cost relative to its functional lifetime.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

It has been found in accordance with the invention that an effective coating composition resistant when applied to a substrate to heat, flame and molten metal includes a particulate filler dispersed in an elastomeric binder, in which the filler comprises particles of high aspect ratio in two dimensions relative to a third that co-operate when in a coating to provide a barrier within the binder.

In a first aspect, the invention provides a coating composition resistant to heat, flame and molten metal when applied as coating to a substrate, the composition including an elastomeric binder and a particulate filler dispersed in the binder, wherein the filler comprises particles of high aspect ratio in two dimensions relative to a third that co-operate when in a coating to provide a barrier within the binder.

In a second aspect, the invention provides an assembly resistant to heat, flame and molten metal, comprising a substrate with a coating thereon that includes an elastomeric binder and a particulate filler dispersed in the binder, wherein the filler comprises particles of high aspect ratio in two dimensions relative to a third that co-operate to provide, within the binder, a barrier to protect the substrate from heat, flame and molten metal.

In an application of particular utility, the assembly is a fabric assembly and the substrate a fabric. In this case, the coating may typically have a coating weight in the range 500 to 1000 gsm.

In a third aspect, the invention provides a fabric assembly resistant to spills and splashes of molten metal, comprising a fabric substrate with a coating thereon that includes an elastomeric binder and a particulate filler dispersed in the binder, wherein the filler comprises particles of high aspect ratio in two dimensions relative to a third that co-operate to provide, within the binder, a barrier to protect the fabric substrate from spills and splashes of molten metal.

By “high aspect ratio in two dimensions relative to a third” is meant herein that in two dimensions, the particles are larger than in the third, preferably at least twice as large, more preferably at least 5 times as large. The dimensions are preferably cartesion.

In the fabric assembly of the invention, the elastomeric binder may be a silicone-based binder, the filler may suitably be metakaolin or silicon carbide, and the filler may be present in the proportion 10 to 70 wt % of the total silicone binder and filler content (after evaporation of solvent), more preferably 15 to 60 wt %, most preferably 20 to 50 wt %.

In a fourth aspect, the invention provides a fabric assembly resistant to spills and splashes of molten metal, comprising a fabric substrate with a coating thereon that includes an elastomeric silicone-based binder and a particulate filler dispersed in the binder comprising metakaolin or silicon carbide.

Preferably, in the fabric assembly of the invention, the silicone resin is dimethylsiloxane and the polysiloxane is polydimethylsiloxane.

Preferably, the fabric is a fabric substantially composed of aramid fibres.

The invention still further provides, in a fifth aspect, a flame resistant building product comprising a substrate sheet or panel with a coating thereon that includes an elastomeric binder and a particulate filler dispersed in the binder, wherein the filler comprises particles of high aspect ratio in two dimensions relative to a third that co-operate to provide, within the binder, a barrier to protect the sheet or panel from flame.

Preferably, in this building product, the elastomeric binder is a silicone-based binder and the filler is expandable graphite or metakaolin.

In a sixth aspect of the invention, there is provided a flame resistant building product comprising a substrate sheet or panel with a coating thereon that includes an elastomeric silicone-based binder and a particulate filler dispersed in the binder comprising expandable graphite or metakaolin.

In all aspects of the invention, the coating and its substrate may be overlaid by another layer whereby the coating is an intermediate layer of a composite laminated structure.

The invention further extends to a method of treating a substrate, e.g. a fabric, to render it more resistant to heat, flame and/or molten metal, comprising applying to the substrate a coating of a coating composition according to the first aspect of the invention.

In general, the elastomeric binder is preferably a silicone-based binder, more preferably a silicone-based binder formed from mixing a silicone resin with a polysiloxane. Conveniently, the silicone resin may be a dimethylsiloxane and the polysiloxane may be polydimethylsiloxane.

In some applications, methylated silica may be dispersed in the elastomeric binder in addition to the filler.

The structure of a high aspect ratio in two dimensions relative to a third implies a generally flat, plate-like structure so that in situ the particles align and disperse over the substrate as a protective cladding or armour of co-operating platelets.

Suitable fillers include metakaolin, expandable graphite, silicon carbide and boron nitride. Fumed silica may be satisfactory in the appropriate form. However, metakaolin is found to be especially effective for fabric substrates, as a protection against splashes and spills of molten metal, while expandable graphite is especially effective for building products and other solid substrates, especially panels of reconstituted wood.

The preferred form of silicon carbide is crystal flakes of silicon carbide.

Preferably, the filler is present in the proportion 10 to 70 wt % of the total silicone binder and filler content, more preferably 15 to 60 wt %, most typically in the proportion 20 to 50 wt % of the total silicone binder and filler content (after evaporation of solvent).

The coating may typically be applied to a substrate in two or more passes. In some applications it may be necessary to avoid the presence of entrapped air that bubbles out on drying, causing an unacceptable adhesion to the substrate and a bubbled appearance. In other applications such entrapped air may be useful in enhancing the protection against radiant heat. Useful methods of coating may include knife coating (over air, roll or rubber sleeve), reverse roll/forward roll, dip/immersion coating, kiss roll (lick roll), bar coating, rotogravure, extrusion or spraying.

It may be preferred to provide a textured surface by applying the coating in a plurality of passes, including a non-textured base layer and a final textured layer.

One or more different forms of silica may also be provided as secondary fillers, e.g. a methylated silica.

An effective silicone to serve as the silicone-based binder is primarily dimethylsiloxane, preferably dimethylvinyl-terminated. A suitable such silicone-based binder is a catalyst-curable silicone supplied by Dow Corning Corporation as a textile printing ink base under the code identifier DC9601: the matching catalyst has the product code identifier DC9600. This material primarily consists of dimethylsiloxane (dimethylvinyl-terminated) and trimethylated silica.

The coating composition is preferably susceptible to application in an aqueous solvent. The coating is preferably textured at its outer surface, for example by exhibiting an array of relatively elevated points or regions. It has been observed that a textured surface for the coating increases the reliability of deflection of molten metal by the coating and reduces the retention, including temporary retention, of molten metal on the coating surface.

It is thought that a contributing factor to the effectiveness of the coating composition of the invention in certain applications may be the formation of a thin surface layer of nanodimensional silica particles, derived from breakdown of the silicone matrix when the coating surface is first exposed to a temperature above a threshold, thought to be in the region of 300° C. or so. Thereafter, the coating may comprise a silicone binder with a thin surface layer of nanodimensional silica and, dispersed in the silicone below this surface layer, microdimensional filler particles.

The coating composition or coating may include as desired other components such as a flame retardant additive (especially with non-fabric articles) or a hand modifier additive.

Preferably, where the coating composition is provided as a coating on a fabric, the fabric includes at least an outer layer in contact with the coating that is comprised of non-melt fibres or filaments. Aramid fibres, both meta-aramids (e.g. Nomex™) or para-aramids (e.g. Kevlar™), are a good such fibre. A substrate fabric composed primarily of meta-aramid fibres is especially suitable because such a fabric is strong, pliable and pleasant to wear, and the fibres have a high limiting oxygen index. They also exhibit good resistance to abrasion and to organic solvents, are non-conductive and have good fabric integrity at elevated temperatures. It is thought that wool and wool composites, especially wool/cotton composites, may exhibit an acceptable performance. The wool fibres should preferably be shrink resist treated and are optionally flame resist treated.

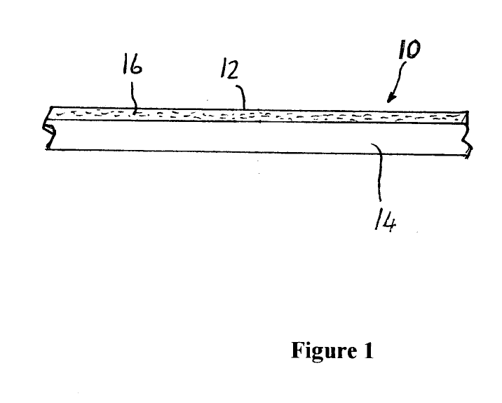

FIG. 1 depicts a coating assembly that is an embodiment of the second to sixth aspects of the invention, comprising a coating 12 on a substrate 14. Substrate 14 may be a fabric, a sheet or panel. Coating 12 includes an elastomeric binder and a particulate filler 16 dispersed in the binder, wherein the filler comprises particles of high aspect ratio in two dimensions relative to a third that co-operate to provide, within the binder, a barrier to protect the substrate from heat, flame and molten metal.

As used herein, except where the context requires otherwise, the term “comprise” and variations of the term, such as “comprising”, “comprises” and “comprised”, are not intended to exclude further additives, components, integers or steps.

### EXAMPLE 1

A number of formulations of coating composition were prepared and applied, by laboratory knife-edge coating techniques, to three different fabric substrates to produce a number of sample fabric assemblies.

The resultant four groups of samples are described in Table 1, which also sets out the coating characteristics (thickness and mass per unit area) for each sample.

A first, reference, group of samples comprised an unfilled silicone coating on a fibreglass mat. The other groups comprised a metakaolin-filled silicone composition on Proban™ and Nomex™ fabric substrates, and a silica-filled silicone composition on Proban™. Proban is based on Rhodia-treated 85% cotton/15% high-tenacity nylon blend while Nomex is a fabric based on meta-aramid fibres.

Each filled coating composition was prepared by first mixing complementary volumes of the catalyst-curable silicone DC9601 and of polydimethylsiloxane (PDMS). A small amount of methylethylketone (MEK) was added to disperse the silicone/PDMS mix and provide the appropriate coating viscosity. The respective filler was slowly added while mixing: most of the solvent evaporated at this stage but allowed the filler to be added. The catalyst DC9600 was now added while mixing continuously, and the substrate coated using a knife-over-air set up. Three coats were required per 500 gsm coating weight. Each coat was dried for 6 min at 150° C.

Each coated fabric was evaluated in accordance with International Standard ISO 9185:1990 (“Protective Clothing—Assessment of resistance of materials to molten metals splash”). The Australian/New Zealand equivalent standard is AS/NZS 4502.4:1997 (“Methods for evaluation of clothing for protection against heat and fire, Part 4—Evaluation of the behaviour of materials and material assemblies when exposed to heavy splashes of molten metal”).

The test metal was molten 316 stainless steel at a melt temperature of around 1600° C. transferred from a holding furnace into a 1000° C. pre-heated crucible held in the testing rig and poured automatically over the samples to be tested. The poured mass of stainless steel was 350 to 400 g from a height of 220 mm onto the fabric, which was inclined at an angle to the pouring direction of 40°. The fabric was retained on an acetate film that had been assessed against a PVC artificial skin stimulant film. Damage to the artificial skin was assessed according to an accepted six grade rating scheme in which rating A was no damage, rating B was some discolouration only and ratings C to F entailed burn-through holes according to a range of categories. The results of the test are indicated in Table 1. It will be seen that both metakaolin-filled compositions performed well (the Proban may have imparted “sunburn”), that the silica-filled composition was less effective, and that the reference samples were burnt through.

### EXAMPLE 2

In order to investigate the applicability of the silicone-inorganic mixtures as fire resistant coatings for wood and other building materials, panels of plywood were coated with the silicone coating containing various functional fillers.

The coatings were prepared with the following inorganic additives (and hand mixing for 2 minutes) as follows:

Metakaolin (calcined kaolinite)

Name: Metabrite CM70

Source: IMCD Australia Ltd,

Addition level: 30 g Metabrite into 25 g Dow 9601 silicone with 1.25 g catalyst DC9600 with 20 g polydimethylsiloxane.

Curing conditions: 150° C. for 6 min.

Silicon carbide

Name: #1000 grit silicon carbide, Product code: 361535

Source: Kemet Australia +61(0) 29831 4922,

Addition level: 10.8 g Kemet SiC into 25 g Dow 9601 silicone with 1.2 g catalyst DC9600.

Curing conditions: 150° C. for 6 min.

Expandable Graphite

Name: ADT1002

Source: IMCD Australia Ltd.

Addition level: 6.5 g ADT1002 into 25 g Dow 9601 silicone with 1.2 g catalyst DC9600

Curing conditions: 150° C. for 6 min.

A reference assembly comprised glass fabric coated both sides with a silicone rubber based compound. The thickness of the coating was 1.0 mm, and its weight 1090 gsm.

The panels of plywood (8 mm nominal thickness) were coated with various of the above coatings using a 3 mm thickness mask and coated by knife coating. The gram per unit area values are shown in Table 2 below.

A flame test was conducted on the surface of the coated wood panels by direct application of a butane gas torch with flame temperature of 1300° C. at a fixed distance of 10 cm from the sample. The temperature of the backside surface of the plywood panels was measured using a non-contact, infra-red temperature detector to monitor temperature rise.

Table 2 shows the time for flame breakthrough for the various samples.

The uncoated plywood and the silicone/glass cloaked plywood both readily charred and released combustible smoke. Flame breakthrough to the rear side of the test panel occurred in 2 minutes.

The metakaolin-filled silicone coating extended the flame breakthrough time to 4 minutes.

The silicon carbide-filled silicone coating extended the flame breakthrough time to 4.39 mins. However, the 3 mm coating became seriously cracked after heating for 2 minutes. Moreover, penetrating cracks were observed on the panel, which may result in direct transfer of heat to the interior and greatly reduce the duration of fire resistant ability at the fire site.

The expandable graphite-filled silicone coating performed exceptionally well with no signs of charring or burning of the wood even after 10 minutes of sustained heating.

The intumescent char formed by the expandable graphite in the elastomeric silicone resin effectively prevents direct heat transfer to the interior of the wood thereby preserving structural integrity even with the duration of fire resistance being significantly extended. No scorching was observed on the piece of A4 size plywood after heating for 10 minutes.

While these examples focus on the application of the inventive coating composition to fabrics for rendering the fabrics more resistant to splashes and spills of molten metal, it will be understood that the coating composition can also be effectively applied to other substrates such as building panels. For example, the composition may be effective to significantly enhance the fire rating of a board formed from wood, such as a plywood panel, precoated or coated on site.

It will be understood that the invention disclosed and defined in this specification extends to all alternative combinations of two or more of the individual features mentioned or evident from the text. All of these different combinations constitute various alternative aspects of the invention.

TABLE 1
Coating characteristics and molten metal test results for coated fabrics

| | | | Observation |
|---|---|---|---|
| | | | of |
| | | Mass per | skin simulant |
| | | Unit Area | after molten |
| Description | Thickness (mm) | (g/sq. m) | metal testing |
| Silicon-coated | 0.828, 0.822, 0.812, 0.816, | 1092 gsm | Burn through |
| glass mat | 0.830, 0.835, 0.823, 0.807, | | |
| | 0.812, 0.814 | | |
| Metakaolin- | 0.783, 0.774, 0.777, 0.797, | 854 gsm | Some |
| filled- | 0.870, 0.856, 0.844 | | discoloration |
| silicone on | | | and |
| Proban | | | localized |
| | | | softening |
| Metakaolin- | 0.706, 0.702, 0.809, 0.712, | 768 gsm | No |
| filled- | 0.771, 0.784, 0.728, 0.663, | | significant |
| silicone on | 0.724 | | effect |
| Nomex | | | |
| Silica-filled- | 1.154, 0.820, 1.160, 0.885, | 852 gsm | Obvious |
| silicone on | 0.886, 0.980, 1.051 | | localized |
| Proban | | | charring |
| | | | and |
| | | | discoloration |

TABLE 2
Coating characteristics and flame test results for coated plywood

| | | Mass of | Mass per | Time for flame |
|---|---|---|---|---|
| | Coating | Coating | Unit Area | break-through |
| Sample | Dimensions | (g) | (gsm) | (minutes) |
| Uncoated wood | — | — | | 2.01 mins |
| Neat Silicone | 16.8 × 24.6 cm | 103.6 | 2486 2506 | 3.02 mins |
| Metakaolin 1 | 16.8 × 24.6 cm | 150.1 | 3630 | Average |
| Metakaolin 2 | 16.8 × 24.6 cm | 145 | 3507 | 4.00 mins |
| Silicon Carbide 1 | 16.8 × 24.6 cm | 133 | 3217 | Average |
| Silicon Carbide 2 | 16.6 × 24.3 cm | 131 | 3247 | 4.39 mins |
| Exp Graphite 1 | 16.6 × 24.3 cm | 113.5 | 2813 | Average |
| Exp Graphite 2 | 16.8 × 20.2 cm | 100 | 2940 | >10 mins |

1. A coating composition resistant to heat, flame and molten metal when applied as coating to a substrate, the composition including an elastomeric binder and a particulate filler dispersed in the binder, wherein the filler comprises particles of high aspect ratio in two dimensions relative to a third that co-operate when in a coating to provide a barrier within the binder.

2. A coating composition according to claim 1 wherein the elastomeric binder is a silicone-based binder.

3. A coating composition according to claim 2 wherein the silicone-based binder is formed from mixing a silicone resin with a polysiloxane.

4. A coating composition according to claim 3 wherein the silicone resin is a dimethylsiloxane and the polysiloxane is polydimethylsiloxane.

5. A coating composition according to claim 2 wherein a methylated silica is dispersed in the elastomeric binder in addition to said filler.

6. A coating composition according to claim 1 wherein said filler is metakaolin.

7. A coating composition according to claim 1 wherein said filler is expandable graphite.

8. A coating composition according to claim 1 wherein said filler is silicon carbide.

9. A coating composition according to claim 1 wherein the filler is present in the proportion 10 to 70 wt % of the total silicone binder and filler content.

10. A coating composition according to claim 1 wherein the filler is present in the proportion 20 to 50 wt % of the total silicone binder and filler content.

11. An assembly resistant to heat, flame and molten metal, comprising a substrate with a coating thereon that includes an elastomeric binder and a particulate filler dispersed in the binder, wherein the filler comprises particles of high aspect ratio in two dimensions relative to a third that co-operate to provide, within the binder, a barrier to protect the substrate from heat, flame and molten metal.

12. An assembly according to claim 11 wherein the elastomeric binder is a silicone-based binder.

13. An assembly according to claim 12 wherein the silicone-based binder is formed from mixing a silicone resin with polysiloxane.

14. An assembly according to claim 13 wherein the silicone resin is a dimethylsiloxane and the polysiloxane is polydimethylsiloxane.

15. An assembly according to claim 12 wherein a methylated silica is dispersed in the elastomeric binder in addition to said filler.

16. An assembly according to claim 11 wherein said filler is metakaolin.

17. An assembly according to claim 11 wherein said filler is expandable graphite.

18. An assembly according to claim 11 wherein said filler is silicon carbide.

19. An assembly according to claim 11 wherein the filler is present in the proportion 10 to 70 wt % of the total silicone binder and filler content.

20. An assembly according to claim 11 wherein the filler is present in the proportion 20 to 50 wt % of the total silicone binder and filler content.

21. An assembly according to claim 11 wherein the assembly is a fabric assembly and the substrate a fabric.

22. A fabric assembly resistant to spills and splashes of molten metal, comprising a fabric substrate with a coating thereon that includes an elastomeric binder and a particulate filler dispersed in the binder, wherein the filler comprises particles of high aspect ratio in two dimensions relative to a third that co-operate to provide, within the binder, a barrier to protect the fabric substrate from spills and splashes of molten metal.

23. A fabric assembly according to claim 22 wherein the elastomeric binder is a silicone-based binder and said filler is metakaolin or silicon carbide present in the proportion 40 to 70 wt % of the total silicone binder and filler content.

24. A fabric assembly according to claim 23 wherein the filler is present in the proportion 20 to 50 wt % of the total silicone binder and filler content.

25. A fabric assembly resistant to spills and splashes of molten metal, comprising a fabric substrate with a coating thereon that includes an elastomeric silicone-based binder and a particulate filler dispersed in the binder comprising metakaolin or silicon carbide.

26. A fabric assembly according to claim 23 wherein the silicone resin is a dimethylsiloxane and the polysiloxane is polydimethylsiloxane.

27. A fabric assembly according to claim 21 wherein the coating has a coating weight in the range 500 to 1000 gsm.

28. A fabric assembly according to claim 21 wherein the substrate fabric is a fabric substantially composed of aramid fibres.

29. A fabric assembly according to claim 21 wherein the coating has a textured surface.

30. A flame resistant building product comprising a substrate sheet or panel with a coating thereon that includes an elastomeric binder and a particulate filler dispersed in the binder, wherein the filler comprises particles of high aspect ratio in two dimensions relative to a third that co-operate to provide, within the binder, a barrier to protect the sheet or panel from flame.

31. A flame resistant building product according to claim 30 wherein the elastomeric binder is a silicone-based binder and said filler is expandable graphite or metakaolin.

32. A flame resistant building product comprising a substrate sheet or panel with a coating thereon that includes an elastomeric silicone-based binder and a particulate filler dispersed in the binder comprising expandable graphite or metakaolin.

33. A flame resistant building product according to claim 30 wherein the silicone resin is a dimethylsiloxane and the polysiloxane is polydimethylsiloxane.

34. A method of treating a substrate to render it resistant to heat, flame and/or molten metal, comprising applying to the substrate a coating of a coating composition according to claim 1.
